(19) United States
(12) Patent Application Publication
(10) Pub. No.: US 2025/0184682 A1
(43) Pub. Date: Jun. 5, 2025

(54) Apparatus, Methods and Computer Programs for Enabling Rendering of Spatial Audio

(71) Applicant: NOKIA TECHNOLOGIES OY, Espoo (FI)

(72) Inventors: Mikko-Ville Laitinen, Espoo (FI); Juha VILKAMO, Helsinki (FI)

(21) Appl. No.: 18/833,452

(22) PCT Filed: Jan. 11, 2023
(86) PCT No.: PCT/FI2023/050024

§ 371 Date: Jul. 26, 2024

(30) Foreign Application Priority Data
Feb. 3, 2022 (GB) 2201377.5

(51) Int. Cl. H04S 7/00; G10L 19/008

(52) U.S. Cl. CPC H04S 7/302; G10L 19/008

(57) ABSTRACT

Examples of the disclosure relate to apparatus, methods and computer programs that enable rendering of spatial audio including both direct and indirect audio. The apparatus can be configured to obtain a spatial audio signal including one or more audio signals and associated spatial metadata. The associated spatial metadata is configured to enable rendering of spatial audio from the one or more audio signals. The spatial audio includes direct audio and indirect audio. The apparatus is also configured to use, at least the associated spatial metadata to determine directional distribution information for the indirect audio. The apparatus is also configured to determine rendering information corresponding to the determined directional distribution information and enable rendering of the spatial audio using the determined rendering information, the one or more audio signals and the associated spatial metadata.

### TECHNOLOGICAL FIELD

Examples of the disclosure relate to apparatus, methods and computer programs for enabling rendering of spatial audio. Some relate to apparatus, methods and computer programs for enabling rendering of spatial audio that comprises both direct and indirect audio.

### BACKGROUND

Spatial audio enables spatial properties of a sound scene to be reproduced for a user so that the user can perceive the spatial properties. This can provide an immersive audio experience for a user or could be used for other applications.

### BRIEF SUMMARY

According to various, but not necessarily all, examples of the disclosure there may be provided an apparatus comprising means for:
obtaining a spatial audio signal comprising one or more audio signals and associated spatial metadata wherein the associated spatial metadata is configured to enable rendering of spatial audio from the one or more audio signals and wherein the spatial audio comprises direct audio and indirect audio;
using, at least the associated spatial metadata to determine directional distribution information for the indirect audio;
determining rendering information corresponding to the determined directional distribution information; and
enabling rendering of the spatial audio using the determined rendering information, the one or more audio signals and the associated spatial metadata.

The indirect audio may comprise non-directional audio.

The indirect audio may comprise diffuse audio.

The determined directional distribution information may indicate one or more directions associated with the indirect audio.

The rendering information may comprise a target covariance matrix of the audio signals.

The rendering information may comprise diffuse sound gains for channels of a multichannel loudspeaker arrangement.

The means may be for using, at least the associated spatial metadata to determine direction information for the direct audio

The associated spatial metadata may comprise information that enables mixing of audio signals so as to enable rendering of the spatial audio in a selected audio format.

The associated spatial metadata may comprise, for one or more frequency sub-bands, information indicative of;
a sound direction, and
sound directionality.

The associated spatial metadata may comprise, for one or more frequency sub-bands one or more prediction coefficients.

The associated spatial metadata may comprise one or more coherence parameters.

According to various, but not necessarily all, examples of the disclosure there may be provided an electronic device comprising an apparatus as described herein wherein the electronic device is at least one of: a telephone, a camera, a computing device, a teleconferencing apparatus.

According to various, but not necessarily all, examples of the disclosure there may be provided a method comprising:
obtaining a spatial audio signal comprising one or more audio signals and associated spatial metadata wherein the associated spatial metadata is configured to enable rendering of spatial audio from the one or more audio signals and wherein the spatial audio comprises direct audio and indirect audio;
using, at least the associated spatial metadata to determine directional distribution information for the indirect audio;
determining rendering information corresponding to the determined directional distribution information; and
enabling rendering of the spatial audio using the estimated target spatial features, the one or more audio signals and the associated spatial metadata.

According to various, but not necessarily all, examples of the disclosure there may be provided a computer program comprising computer program instructions that, when executed by processing circuitry, cause:
obtaining a spatial audio signal comprising one or more audio signals and associated spatial metadata wherein the associated spatial metadata is configured to enable rendering of spatial audio from the one or more audio signals and wherein the spatial audio comprises direct audio and indirect audio;
using, at least the associated spatial metadata to determine directional distribution information for the indirect audio;
determining rendering information corresponding to the determined directional distribution information; and
enabling rendering of the spatial audio using the estimated target spatial features, the one or more audio signals and the associated spatial metadata.

### BRIEF DESCRIPTION

Some examples will now be described with reference to the accompanying drawings in which:

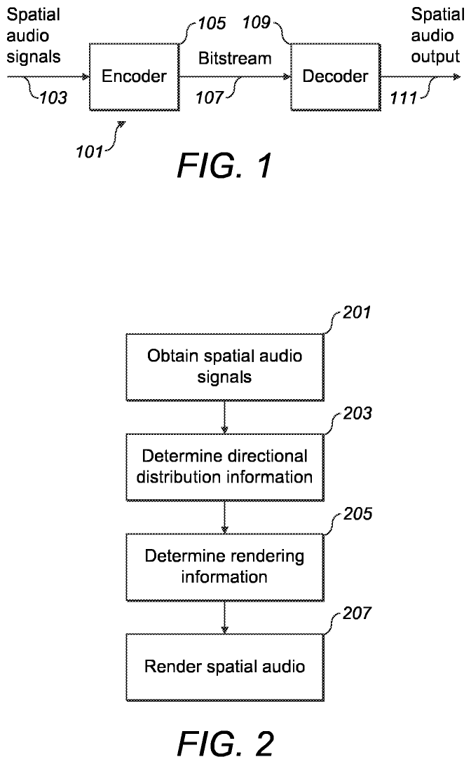

FIG. 1 shows an example system;

FIG. 2 shows an example method;

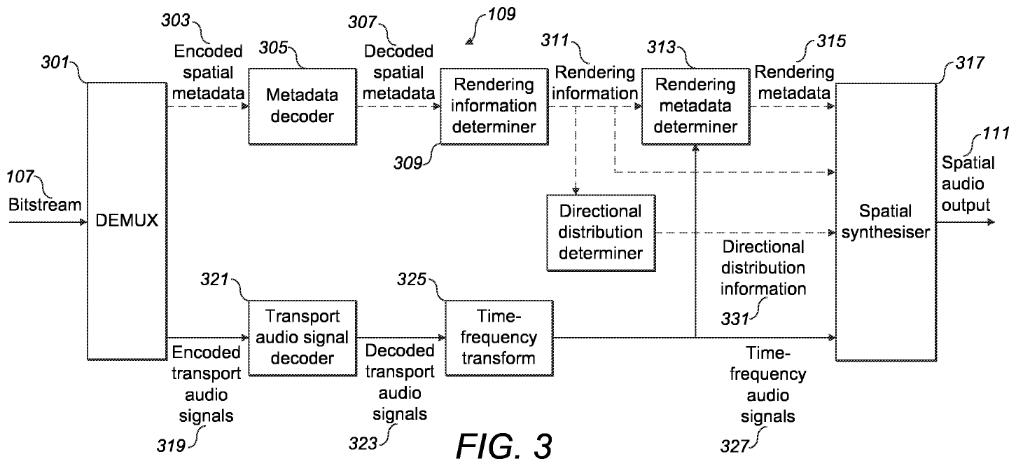

FIG. 3 shows an example decoder;

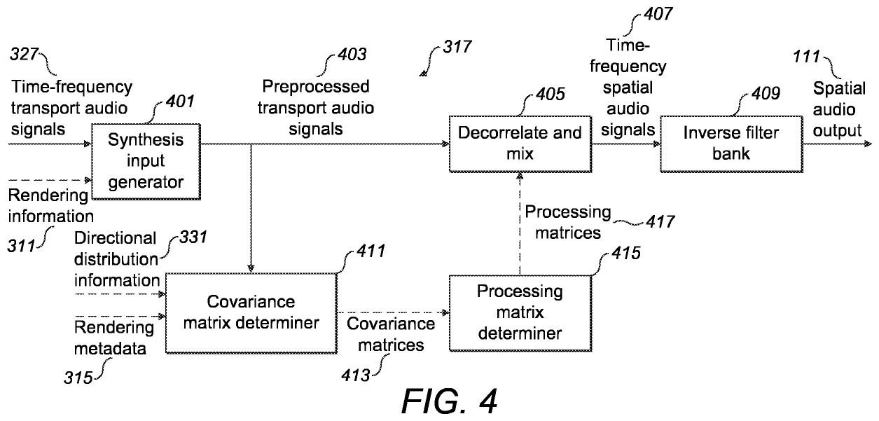

FIG. 4 shows an example spatial synthesizer; and

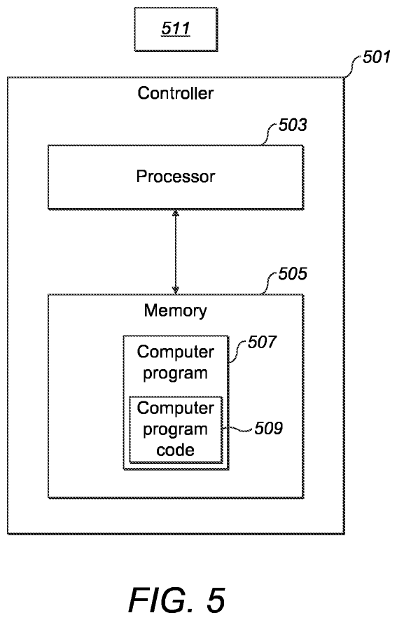

FIG. 5 shows an example apparatus.

### DETAILED DESCRIPTION

Examples of the disclosure enable rendering of spatial audio comprising both direct and indirect audio. In some circumstances the finite temporal and/or frequency resolution of the audio processing can lead to some audio being identified as indirect audio or diffuse audio even though this is not the case in the original sound scene.

For example, in Directional Audio Coding (DirAC) the direction and diffuseness of the audio are analysed in frequency bands. This analysis is based on the intensity. If original sound scene comprises only one dominant source within a time-frequency tile it is likely to be analysed to be non-diffuse. However, if the original sound scene comprises two or more sound sources with similar levels of dominance there may be some time-frequency tiles where the sound from the different sources have similar intensity levels. This can lead to the sound being treated as diffuse or indirect sound even though this is not the case within the original sound scene. This leads to other sounds being analysed as diffuse in addition to true diffuse sounds.

Examples of the disclosure address this problem by estimating directional distribution information of the indirect audio based on spatial metadata associated with the audio signal. The directional distribution information can then be used to enable rendering of the audio signals and avoid non-diffuse sounds being analysed as purely diffuse sounds with a fully surrounding spatial distribution. This leads to improved spatial audio.

FIG. 1 shows an example system 101 that can be used to implement examples of the disclosure. The system comprises an encoder 105 and a decoder 109. In some examples the encoder 105 and the decoder 109 can be in different devices. In some examples the encoder 105 and the decoder 109 could be in the same device.

The system 101 is configured so that the encoder 105 obtains an input comprising spatial audio signals 103. In this example the spatial audio signals 103 could be first order Ambisonic (FOA) signals. Other types of spatial audio signals 103 could be used in other examples of the disclosure.

The spatial audio signals 103 can be obtained from two or more microphones configured to capture spatial audio. In examples where the audio signals 103 comprise FOA audio signals the FOA audio signals could be obtained from a dedicated Ambisonics microphones such as an Eigenmike or any other suitable means. The spatial audio signals represent a sound scene. The sound scene can comprise one or more sound sources. In some examples the spatial audio signals 103 could be obtained from a source other than microphones, for example they could comprise multichannel loudspeaker signals, such as 5.1 signals.

The spatial audio signals 103 can comprise direct audio and indirect audio. The direct audio can comprise audio that arrives at the microphones from a particular direction. The direct audio can comprise audio from one or more dominant sound sources within a sound scene. The indirect audio can comprise background or ambient noise that can appear to be non-directional and/or that arrives from a broad range of directions. The indirect audio can also comprise audio that might be estimated to be non-directional or diffuse but is not actually diffuse in the original sound scene. For instance, if there are a plurality of sound sources of similar level of intensity these could be analysed to be non-directional or if there are reflections of one or more sound sources.

The encoder 105 can comprise any means that can be configured to encode the audio signals 103 to provide a bitstream 107 as an output. The encoder 105 can be configured to use parametric methods to encode the audio signals 103. The parametric methods could comprise Immersive Voice and Audio Services (IVAS) methods or any other suitable type of methods. The encoder 105 can be configured to use the audio signals 103 to determine transport audio signals and spatial metadata. The transport audio signals and spatial metadata can then be multiplexed to provide the bitstream 107.

In some examples the bitstream 107 can be transmitted from a device comprising the encoder 105 to a device comprising the decoder 109. In some examples the bitstream 107 can be stored in the device comprising the encoder 105 and can be retrieved and decoded by a decoder 109 when appropriate.

The decoder 109 is configured to receive the bitstream 107 as an input. The decoder 109 comprises means that can be configured to decode the bitstream 107. The decoder 109 can decode the bitstream to the transport audio and the spatial metadata. The decoder 109 can be configured to render the spatial audio output 111 using the decoded spatial metadata. The spatial audio output 111 could be provided in any suitable format such as binaural audio signals.

FIGS. 2 to 4 show example methods and parts of the system 101 that can be used to enable determining of a directional distribution information for indirect audio and use this to render improved spatial audio.

FIG. 2 shows an example method that can be used to enable rendering of spatial audio in different audio formats. The method could be implemented in a system 101 such as the system 101 shown in FIG. 1.

The method comprises, at block 201, obtaining a spatial audio signal 103. The spatial audio signal 103 can comprise an encoded audio signal. The audio signal can comprise a plurality of channels of audio, or a single channel of audio. In some examples the spatial audio signal 103 can comprise an audio signal that has not been encoded such as audio signal based on signals from microphones integrated to an apparatus or any other suitable type of audio.

The spatial audio signal 103 can comprise one or more audio signals and associated spatial metadata. The associated spatial metadata is configured to enable rendering of spatial audio from the one or more audio signals.

The spatial metadata can comprise information that enables mixing of audio signals so as to enable rendering of the spatial audio in a selected audio format.

The spatial metadata can be provided in frequency sub-bands. The spatial metadata could comprise, for one or more frequency sub-bands, information indicative of a sound direction and information indicative of sound directionality. The sound directionality can be an indication of how directional or non-directional the sound is. The sound directionality can provide an indication of whether the sound is ambient sound or provided from point sources. The sound directionality can be provided as energy ratios of direct to ambient sound or in any other suitable format. In some examples the spatial metadata comprises one or more coherence parameters, or any other suitable parameters.

The spatial metadata can be provided in any suitable format corresponding to the format used for the audio signals and/or rendering. For example, if the format used is FOA signals the spatial metadata can comprise, for one or more frequency sub-bands, information indicative of how to predict FOA signals from the audio signal. The audio signal can comprise a plurality of channels of audio, or a single channel of audio. Such information could comprise prediction coefficients for predicting FOA signals from the transport audio signal. The transport audio signal can comprise a plurality of channels of audio, or a single channel of audio. For example, the omnidirectional signal W of FOA can be used as the transport audio signal, and the prediction coefficients can be used to predict dipole signals X, Y, and Z from the transmitted signal W.

The spatial audio comprises direct audio and indirect audio. The indirect audio can comprise non-directional audio. In some examples the indirect audio can comprise diffuse audio. The indirect audio can also comprise audio that is not truly indirect in the original sound scene but could be analysed as being indirect due to limitations in the frequency and/or temporal and/or spatial resolution of the processing.

The indirect audio can comprise audio that covers a larger range of angles than the direct audio. The direct audio can originate from a single angle or narrow angular range while indirect audio can originate from a broad range of angles. In some examples the indirect audio could originate from all directions instead of from a specific direction.

At block 203 the method comprises using, the associated spatial metadata to determine directional distribution information for the indirect audio. In some examples information in addition to the spatial metadata could be used to determine the directional distribution information.

The determined directional distribution information indicates one or more directions associated with the indirect audio. For instance, if the indirect audio comprises audio from a plurality of sound sources of similar levels of dominance, the directional distribution information could comprise information relating to the respective directions of the different sound sources.

The determined directional distribution information can comprise information that can be used to tune the spatialization of the audio in order to render the indirect audio from the correct directions instead of rendering the indirect audio as surrounding or fully surrounding.

At block 205 the method comprises determining rendering information corresponding to the determined directional distribution information. The rendering information can comprise target spatial features. The target spatial features comprise features that should enable a listener to perceive the spatial audio with the sound sources in the correct locations corresponding to the original sound scene.

The rendering information can comprise parameters that indicate how the directional distribution information corresponds to spatial audio features that could be perceived by a listener.

The rendering information can be determined in any suitable format. The format that is used for the rendering information can be dependent upon the format that is to be used for the spatial audio output 111. For instance, the rendering information could comprise a target covariance matrix of the audio signals or diffuse sound gains for channels of a multichannel loudspeaker arrangement or any other suitable type of information. The diffuse sound gains can provide an approximation of how diffuse the sound was and how this should be spatially distributed.

At block 207 the method comprises enabling rendering of the spatial audio using the determined rendering information, the one or more audio signals and the associated spatial metadata.

In some examples the method also comprises determining directional distribution information for the direct audio as well as for the indirect audio. The spatial metadata, and any other suitable information, can be used to determine the directional distribution information for the direct audio.

FIG. 3 schematically shows an example decoder 109. The example decoder 109 can be provided within a system 101 such as the system of FIG. 1. The example decoder 109 can be configured to implement methods such as the methods of FIG. 2 so as to enable the rendering of improved spatial audio.

The decoder 109 receives the bitstream 107 as an input. The bitstream 107 can comprise spatial metadata and corresponding audio signals. The audio signals comprise direct audio and indirect audio.

The bitstream 107 is provided to a demultiplexer 301. The demultiplexer 301 is configured to demultiplex the bitstream 107 into a plurality of streams. In the example of FIG. 3 the demultiplexer 301 demultiplexes the bitstream 107 into a first stream and a second stream. The first stream comprises the encoded spatial metadata 303 and the second stream comprises the encoded transport audio signals 319.

The encoded transport audio signals 319 are provided to a transport audio signal decoder 321. The transport audio signal decoder 321 is configured to decode the encoded transport audio signals 319 to provide decoded transport audio signals 323 as an output. The processes that are used to decode the encoded transport audio signals 319 can comprise corresponding processes that were used by the encoder 105 to encode the audio signals. The transport audio signal decoder 321 could comprise an Enhanced Voice Services (EVS) decoder, an Advanced Audio Coding (AAC) decoder or any other suitable type of decoder.

The decoded transport audio signals 323 are provided to a time-frequency transform block 325. The time-frequency transform block 325 is configured to change the domain of the decoded transport audio signals 323. In some examples the time-frequency transform block 325 is configured to convert the decoded transport audio signals 323 into a time-frequency representation. The time-frequency transform block 325 can be configured to use any suitable means to change the domain of the decoded transport audio signals 323. For instance, the time-frequency transform block 325 can be configured to use a short-time Fourier transform (STFT), a complex-modulated quadrature mirror filter (QMF) bank, a low-delay variant thereof or any other suitable means.

The time-frequency transform block 325 provides time-frequency transport audio signals 327 as an output.

The encoded first spatial metadata 303 is provided as an input to a metadata decoder 305. The metadata decoder 305 is configured to decode the encoded first spatial metadata 303 to provide decoded spatial metadata 307 as an output. The processes that are used to decode the encoded spatial metadata 303 can comprise corresponding processes that were used by the encoder 105 to encode the first spatial metadata. The metadata decoder 305 could comprise any suitable type of decoder.

The decoded spatial metadata 307 can be provided in any suitable format. For instance, if the audio signals have been encoded for FOA rendering then the decoded spatial metadata 307 can be in a format that enables FOA rendering. For instance, the decoded spatial metadata 307 could comprise FOA prediction coefficients. The FOA prediction coefficients comprise information that can be converted to rendering information such as mixing matrices. The rendering information or mixing matrices can comprise any information that indicates how the audio signals should be mixed and/or decorrelated in order to produce an audio output in an Ambisonic format. Different types of audio formats could be used in other examples.

The decoded first spatial metadata 307 is provided as an input to a rendering information determiner block 309. The rendering information determiner block 309 can be configured to determine the rendering information 311. The rendering information 311 can comprise one or more mixing matrices and/or any other suitable rendering information. The rendering information determiner block 309 provides rendering information 311 such as mixing matrices as an output. The rendering information 311 can be different to the rendering information obtained at block 205 in FIG. 2 which is corresponding to the directional distribution information.

The rendering information 311 can be determined based on the decoded spatial metadata 307.

In examples where the audio signals have been encoded for FOA rendering the rendering information 311 can comprises mixing matrices. The mixing matrices can be written as A(i, j, k, n) where i is the output channel index, j the input channel, k the frequency band, and n the temporal frame. The mixing matrices can be used to render FOA signals by applying them to the transport audio signals, and/or decorrelated versions of the transport audio signals.

Other types of rendering information could be obtained in other examples. In some examples the decoded spatial metadata 307 could already be the mixing matrices or other rendering information and so, in such examples, it is not necessary to use a rendering information determiner block 309.

The mixing matrices, or other rendering information, can be used to render the decoded time-frequency transport audio signals 327. As an example, the decoded time-frequency transport audio signals 327 can be denoted as a column vector s(b, n), where b is a frequency bin index and the rows of the vector represent the transport audio signal channel. The number of rows could be between one and four depending on the applied bit rate and any other suitable factors. If the number of channels is less than four then the number of rows in the vector s(b, n) will also be less than four. In such examples the column vector can be appended with new channels to form a vector s′(b, n) with four rows. The new channels can be decorrelated versions of the first channel signal of s(b, n).

The FOA signals can then be rendered by

$$y ( b , n ) = A ( k , n ) {s}^{′} ( b , n )$$

where k is the frequency band where bin frequency bin b resides. The spatial metadata for a frequency band can correspond to one or more frequency bins of the filter bank that has been used for transforming the audio signals.

In the above equation the mixing matrix A can be written as:

$$A ( k , n ) = [ \begin{matrix}A ( 1 , 1 , k , n ) & … & A ( 1 , 4 , k , n ) \\ ⋮ & ⋱ & ⋮ \\ A ( 4 , 1 , k , n ) & … & A ( 4 , 4 , k , n )\end{matrix} ]$$

This notation implies that the temporal resolution of the signals s(b, n) and of the mixing matrices A(k, n) (that is, the metadata temporal resolution) is the same. This could be the case for systems 101 that use filter banks such as the STFT which are configured to apply a coarse temporal resolution. A coarse temporal resolution could use temporal steps of around 20 milliseconds for the filterbank. Other filterbanks could have a finer temporal resolution. In such cases the spatial metadata temporal resolution would be sparser than the resolution of the audio signals. In these examples the same mixing matrix could be applied to a plurality of different time indices of the audio signal or the mixing matrices could be temporally interpolated.

In examples of the disclosure the decoded spatial metadata 307 and/or rendering information obtained from the spatial metadata can be used to determine directional distribution information 331 that indicates directions associated with, at least some of the indirect audio.

In the example shown in FIG. 3 the rendering information 311 is provided as an input to a rendering metadata determiner 313. The rendering metadata determiner 313 also receives the time-frequency transport audio signals 327 as an input.

The rendering metadata determiner 313 is configured to determine rendering metadata 315 that is suitable for rendering spatial audio that is in any suitable format. The format of the rendering metadata 315 can be different to the format that is used for the decoded spatial metadata 307. For example, the decoded spatial metadata 307 could be suitable for FOA format and the rendering metadata 315 could be suitable for other formats such as binaural formats.

In the example of FIG. 3 the rendering metadata 315 comprises direction (azimuth, elevation) θ(k, n), ϕ(k, n) parameters and direct-to-total energy ratio r(k, n) parameters. The parameters are provided in frequency bands. Other types of parameters could be used in other examples of the disclosure. Other parameters could be used instead of the direction parameters and energy ratio parameters or in combination with the direction parameters and energy ratio parameters.

In some examples the decoded spatial metadata 307 could already comprise the direction parameters and energy ratio parameters and/or any other suitable parameters of the rendering metadata 315. In such examples, it is not necessary to use a rendering metadata determiner block 313.

The rendering information 311 is also provided as an input to a directional distribution determiner block 329. The directional distribution determiner block 329 is configured to use the rendering information 311, or spatial metadata or other information obtained from the spatial metadata, to determine directional distribution information. The directional distribution information can be determined both for indirect audio and for direct audio. In some examples the directional distribution information can be determined only for the indirect audio and the directional distribution for the direct audio can be provided by direction parameters of the spatial metadata.

In examples where the rendering information 311 comprises mixing matrices A(i, j, k, n) the mixing matrices A(i, j, k, n) would be forwarded to the directional distribution determiner block 329. In some examples there might be only one transport audio signal, and the rest of audio signals that are to be processed by the mixing matrices A(i, j, k, n) would be decorrelated versions of the single transport audio signal. In other examples there can be more than one transport audio signal. In such cases the energy of the signals has to be taken into account. In cases where there are more than one transport audio signal the directional distribution determiner block 329 can also be configured to receive the time-frequency transport audio signals 327, or the covariance matrices of such signals, as an input.

In examples that use FOA type parameters in the decoded spatial metadata 307 the first columns of the mixing matrices A(i, j, k, n) (that is, j=1) provided as the rendering information 311 correspond to the direct audio, or predominantly to the direct audio. This part of the audio is rendered coherently from the same input, for example, the omnidirectional signal W.

Conversely the other columns of the mixing matrices A(i, j, k, n) (that is, 2≤j≤4) correspond to the indirect audio, or predominantly to the indirect audio. This part of the audio is rendered decorrelated or incoherently.

In examples of the disclosure the directional distribution information 331 can be estimated from the columns of the mixing matrices A(i, j, k, n) that correspond to the indirect audio. For example, they can be estimated from the last three columns of the mixing matrices A(i, j, k, n).

Any suitable process can be used to determine the directional distribution information 331. In some examples the directional distribution information 331 can be estimated by determining gains for the indirect audio. The indirect audio could be diffuse audio. The gains for the indirect audio can be determined in the X, Y, and Z directions. In this example it is assumed that the columns of the mixing matrices A(i, j, k, n) are in X, Y and Z order. In other examples they could be in other orders.

The gains can be given as

$${g}_{x , diff} ( k , n ) = \vert A ( 2 , 2 , k , n ) \vert$$

$${g}_{y , diff} ( k , n ) = \vert A ( 3 , 3 , k , n ) \vert$$

$${g}_{z , diff} ( k , n ) = \vert A ( 4 , 4 , k , n ) \vert$$

These gains can then be added together to determine the sum of the indirect sound gains g_{sum,diff}(k, n) where;

$${g}_{sum , diff} ( k , n ) = {g}_{x , diff} ( k , n ) + {g}_{y , diff} ( k , n ) + {g}_{z , diff} ( k , n )$$

The ratios for the indirect audio are then determined for each of the X, Y, and Z directions

$$\begin{matrix}{r}_{x , diff} ( k , n ) = \frac{{g}_{x , diff} ( k , n )}{{g}_{sum , diff} ( k , n )} \\ {r}_{y , diff} ( k , n ) = \frac{{g}_{y , diff} ( k , n )}{{g}_{sum , diff} ( k , n )} \\ {r}_{z , diff} ( k , n ) = \frac{{g}_{z , diff} ( k , n )}{{g}_{sum , diff} ( k , n )}\end{matrix}$$

The directional distribution information 331 can comprise the ratios for the indirect audio r_{x,diff}(k, n), r_{y,diff}(k, n), and r_{z,diff}(k, n). The ratios for the indirect audio r_{x,diff}(k, n), r_{y,diff}(k, n), and r_{z,diff}(k, n) can be provided as an output of the directional distribution determiner 329.

It is to be note noted that this is merely an example parametrization of the directional distribution information 331. Other parametrizations for the directional distribution information 331 could be used in other examples.

The rendering metadata 315, the time-frequency transport audio signals 327, the rendering information 311 and the directional distribution information 331 are provided as inputs to the spatial synthesizer 317. The spatial synthesizer 317 is configured to use the rendering metadata 315, the time-frequency transport audio signals 327, the rendering information 311 and the directional distribution information 331 to render the spatial audio output 111. The spatial audio output can comprise a binaural output, multichannel loudspeaker signals, Higher order Ambisonic (HOA) signals or any other suitable audio format.

FIG. 4 schematically shows an example spatial synthesizer 317. The example spatial synthesizer 317 can be provided within a decoder 109 such as the decoder 109 shown in FIG. 3.

The spatial synthesizer 317 receives the rendering metadata 315, the time-frequency transport audio signals 327, the directional distribution information 331 and the rendering information 311 as inputs.

As shown in FIG. 4 the time-frequency transport audio signals 327 and the rendering information 311 are provided as inputs to a synthesis input generator 401. The synthesis input generator 401 is configured to convert the time-frequency transport audio signals 327 to a suitable format for processing by the rest of the blocks within the spatial synthesizer 317.

The processes that are performed by the synthesis input generator 401 may be dependent upon the number of transport channels that are used. In examples where the time-frequency transport audio signals 327 comprise a single channel (mono transport) the synthesis input generator 401 can allow the time-frequency transport audio signals 327 to pass through without performing any processing on the time-frequency transport audio signals 327. In some examples the single channel signals could be duplicated to create a signal comprising two or more channels. This can provide a dual-mono or pseudo stereo signal so that all the following blocks in the spatial synthesiser 317 can assume a stereo track even if there was only originally one transport audio signal.

In examples where the time-frequency transport audio signals 327 comprise a plurality of channels the synthesis input generator 401 can be configured to generate a stereo track. The stereo track can represent cardioid patterns towards different directions, such as the left direction and the right direction.

The cardioid patterns can be obtained by using any suitable process. For example, they can be obtained by applying a matrix A′(k, n) to the time-frequency transport audio signals 327. The matrix A′(k, n) comprises the first two rows of matrix A(k, n). This therefore provides W and Y spherical harmonic signals.

After the matrix A′(k, n) has been applied a left-right cardioid beamforming matrix can be applied to provide the pre-processed transport audio signals 403.

The pre-processed transport audio signals x(b, n) 403 can be written as:

$$x ( b , n ) = \frac{1}{2} [ \begin{matrix}1 & 1 \\ 1 & - 1\end{matrix} ] {A}^{′} ( k , n ) {s}^{′} ( b , n )$$

where band k is the band where bin b resides.

The pre-processed transport audio signals x(b, n) 403 are provided as an output of the synthesis input generator 401. The Covariance matrix determiner can be configured to determine input covariance matrices and target covariance matrices.

The pre-processed transport audio signals 403, the rendering metadata 315 and the directional distribution information 331 can be provided as inputs to a covariance matrix determiner 411. The covariance matrix determiner 411 is configured to determine an input covariance matrix and a target covariance matrix. The input covariance matrix represents the pre-processed transport audio signals 403 and the target covariance matrix represents the time-frequency spatial audio signals 407.

The input covariance matrix can be determined from the pre-processed transport audio signals 403 by

$${C}_{x} ( k , n ) = {\sum }_{b = {b}_{low} ( k )}^{{b}_{high} ( k )} x ( b , n ) {x}^{H} ( b , n )$$

where b_{low}(k) and b_{high}(k) are the lowest and highest bins of band k.

As mentioned above, in this example the temporal resolution of the covariance matrix is the same as the temporal resolution of the audio signals. In other examples the temporal resolutions could be different, for example, in examples where filter banks with high temporal selectivity are used.

When there are two or more transport audio signals in of s(b, n), the covariance matrix Cₓ(k, n) can also be formulated by

$${C}_{x} ( k , n ) = \frac{1}{4} [ \begin{matrix}1 & 1 \\ 1 & - 1\end{matrix} ] {A}^{′} ( k , n ) {C}_{s′} ( k , n ) {A}^{′H} ( k , n ) [ \begin{matrix}1 & 1 \\ 1 & - 1\end{matrix} ]$$

Where C_{s′}(k, n) is

$${C}_{s′} ( k , n ) = {\sum }_{b = {b}_{low} ( k )}^{{b}_{high} ( k )} {s}^{′} ( b , n ) {s}^{′H} ( b , n )$$

It is to be noted that s′(b, n) was s(b, n) appended with decorrelated versions of the first channel of s(b, n). Therefore, C_{s′}(k, n) can also be estimated by estimating the covariance matrix of s(b, n), and then zero-padding the result to size 4×4. The zero-padded diagonal entries can then be placed to the first diagonal entry of the estimated covariance matrix.

The target covariance matrix can be determined based on the rendering metadata 315 and the overall signal energy and also the directional distribution information.

The overall signal energy O(k, n) can be obtained as the mean of the diagonal values of Cₓ(k, n), or can be determined based on the omnidirectional component of signal A′(k, n)s′(b, n). Then, in some examples, the rendering metadata 315 comprises a direction θ(k, n), ϕ(k, n) and a direct-to-total ratio parameter r(k, n). If it is assumed that the output is a binaural signal, then the target covariance matrix is

$$\begin{matrix}{C}_{y} ( k , n ) = E ( k , n ) r ( k , n ) h ( k , θ ( k , n ) , ϕ ( k , n ) ) {h}^{H} ( k , θ ( k , n ) , ϕ ( k , n ) ) \\ + E ( k , n ) ( 1 - r ( k , n ) ) {C}_{d} ( k )\end{matrix}$$

where h(k, θ(k, n), ϕ(k, n)) is a head-related transfer function column vector for band k and direction θ(k, n), ϕ(k, n).

h(k, θ(k, n), ϕ(k, n)) is a column vector. The vector comprises two values. The values can be complex values. The values correspond to the Head Related Transfer Function (HRTF) amplitude and phase for a left ear and a right ear. At high frequencies, the HRTF values can comprise real values because phase differences are not needed for perceptual reasons at high frequencies.

Any suitable processes can used to obtain the HRTFs. The HRTFs can be obtained for given directions and frequency.

In the above equation Ca (k) is the indirect audio binaural covariance matrix. In systems that do not use implementations of the disclosure the indirect audio could be assumed to be diffuse. The indirect audio can be assumed to be fully surrounding and originating from all directions.

The indirect audio binaural covariance matrix corresponding to a fully surrounding and diffuse sound distribution can be obtained by selecting a uniform spatial distribution of directions DOA_{d} where d=1 . . . . D and by

$${C}_{bin , diff , uniform} ( k ) = \frac{1}{D} {\sum }_{d = 1}^{D} h ( {DOA}_{d} , k ) {h}^{H} ( {DOA}_{d} , k )$$

In examples of the disclosure the indirect audio is not assumed to always be uniform. The indirect audio is not assumed to be fully diffuse or originating from all directions. The non-uniformity of the indirect audio needs to be taken into account by the indirect audio binaural covariance matrix. As an example, the non-uniformity of the indirect audio can be accounted for as follows.

Initially, indirect binaural covariance matrices are determined for X, Y, and Z. These matrices can be determined as;

$$\begin{matrix}{C}_{bin , diff , x} ( k ) = \frac{{\sum }_{d = 1}^{D} h ( {DOA}_{d} , k ) {h}^{H} ( {DOA}_{d} , k ) \vert x ( {DOA}_{d} ) \vert}{{\sum }_{d = 1}^{D} \vert x ( {DOA}_{d} ) \vert} \\ {C}_{bin , diff , y} ( k ) = \frac{{\sum }_{d = 1}^{D} h ( {DOA}_{d} , k ) {h}^{H} ( {DOA}_{d} , k ) \vert y ( {DOA}_{d} ) \vert}{{\sum }_{d = 1}^{D} \vert y ( {DOA}_{d} ) \vert} \\ {C}_{bin , diff , z} ( k ) = \frac{{\sum }_{d = 1}^{D} h ( {DOA}_{d} , k ) {h}^{H} ( {DOA}_{d} , k ) \vert z ( {DOA}_{d} ) \vert}{{\sum }_{d = 1}^{D} \vert z ( {DOA}_{d} ) \vert}\end{matrix}$$

where x(DOA_{d}), y(DOA_{d}), and z(DOA_{d}) are the Cartesian coordinates corresponding to DOA_{d}. C_{bin,diff,x}(k) comprises a contribution of indirect audio that originates mostly from the X direction, C_{bin,diff,y}(k) comprises a contribution of indirect audio that originates mostly from the Y direction and C_{bin,diff,z}(k) comprises a contribution of indirect audio that originates mostly from the Z direction.

The indirect audio binaural covariance matrix with directional distribution can be determined using the diffuse sound ratios r_{x,diff}(k, n), r_{y,diff}(k, n), and r_{z,diff}(k, n) and the diffuse binaural covariance matrices in X, Y, and Z directions C_{bin,diff,x}(k), C_{bin,diff,y}(k), and C_{bin,diff,z}(k). For example, the indirect audio binaural covariance matrix with directional distribution can be determined by:

$${C}_{d} ( k , n ) = {r}_{x , diff} ( k , n ) {C}_{bin , diff , x} ( k ) + {r}_{y , diff} ( k , n ) {C}_{bin , diff , y} ( k ) + {r}_{z , diff} ( k . n ) {C}_{bin , diff , z} ( k )$$

In examples where the indirect audio ratios r_{x,diff}(k, n), r_{y,diff}(k, n), and r_{z,diff}(k, n) are equal (that is, where each of the ratios is 1/3), the resulting indirect audio binaural covariance matrix C_{d}(k, n) might be close to the uniform diffuse binaural covariance matrix C_{bin,diff,uniform}(k). In some examples, it might be possible to add slight tuning to values of C_{bin,diff,x}(k), C_{bin,diff,y}(k), and C_{bin,diff,z}(k) so that the average of them is exactly C_{bin,diff,uniform}(k). Therefore, rendering of audio signals with an even diffuse distribution (that is where, r_{x,diff}(k, n), r_{y,diff}(k, n), and r_{z,diff}(k, n) are all 1/3) produces the same results as implementations that do not use examples of the disclosure.

The covariance matrix determiner 411 provides covariance matrices 413 as an output. The covariance matrices 413 that are provided as the output can comprise the input covariance matrix Cₓ(k, n) and the target covariance matrix C_{y}(k, n).

In the above equations it is implied that the processing is performed in a unified manner within the bins of each band k. In some examples the processing can be performed with a higher frequency resolution, such as for each frequency bin b. In such examples the equations given above would be adapted so that the covariance matrices are determined for each bin b, but using the parameters of the rendering metadata 315 for the band k where the bin resides.

In some examples the input covariance matrices and the target covariance matrices can be temporally averaged. The temporal averaging could be implemented using infinite impulse repose (IIR), finite impulse response (FIR) averaging or any other suitable type of temporal averaging. The covariance matrix determiner 411 can be configured to perform the temporal averaging so that the temporally averaged covariance matrices 413 are provided as an output.

In this example for obtaining the target covariance matrix only parameters relating to direction and energy ratios have been considered. In other examples other parameters can be taken into consideration when obtaining the target covariance matrix. For example, in addition to the direction and energy ratios spatial coherence parameters, or any other suitable parameters could be considered. The use of other types of parameters can enable spatial audio outputs to be provided in formats other than binaural formats and/or can improve the accuracy with which the spatial sounds can be reproduced.

The processing matrix determiner 415 is configured to receive the covariance matrices 413 Cₓ(k, n) and C_{y}(k, n) as an input. The processing matrix determiner 415 is configured to use the covariance matrices 413 Cₓ(k, n) and C_{y}(k, n) to determine processing matrices M(k, n) and Mᵣ(k, n). Any suitable process can be used to determine the processing matrices M(k, n) and Mᵣ(k, n). In some examples the process that is used can comprise determining mixing matrices for processing audio signals with a measured covariance matrix Cₓ(k, n), so that they attain a determined target covariance matrix C_{y}(k, n). Such methods can be used to generate binaural audio signals or surround loudspeaker signals or other types of audio signals. To formulate the processing matrices the method can comprise using a matrix such as a prototype matrix. The prototype matrix is a matrix that indicates, for the optimization procedure, which kind of signals are meant for each of the outputs. This can be within the constraint that the output must attain the target covariance matrix. In examples where the spatial audio output format is a binaural format, the prototype matrix could be:

$$[ \begin{matrix}1 & 0.01 \\ 0.01 & 1\end{matrix} ]$$

This protype matrix indicates that the signal for the left ear is predominantly rendered from the left pre-processed transport channel and the signal for the right ear is predominantly rendered from the right pre-processed transport channel. In some examples the orientation of the user's head can be tracked. If it is determined that the user is now facing towards the rear half-sphere then the prototype matrix would be:

$$[ \begin{matrix}0.01 & 1 \\ 1 & 0.01\end{matrix} ] .$$

The processing matrix determiner 415 may be configured to determine the processing matrices M(k, n) and Mᵣ(k, n), based on the prototype matrix and the input and target covariance matrices, using means described in Vilkamo, J., Bäckström, T., & Kuntz, A. (2013). Optimized covariance domain framework for time-frequency processing of spatial audio. Journal of the Audio Engineering Society, 61(6), 403-411. The processing matrix determiner 415 is configured to provide the processing matrices M(k, n) and Mᵣ(k, n) 417 as an output.

The processing matrices M(k, n) and Mᵣ(k, n) 417 are provided as an input to a decorrelate and mix block 405. The decorrelate and mix block 405 also receives the pre-processed transport audio signals x(b, n) 403 as an input. The decorrelate and mix block 405 can comprise any means that can be configured to decorrelate and mix the pre-processed transport audio signals x(b, n) 403 based on the processing matrices M(k, n) and Mᵣ(k, n) 417.

Any suitable process can be used to decorrelate and mix the pre-processed transport audio signals x(b, n) 403. In some examples the decorrelating and mixing of the pre-processed transport audio signals x(b, n) 403 can comprise processing the pre-processed transport audio signals x(b, n) 403 with the same prototype matrix that has been applied by the processing matrix determiner 415 and decorrelating the result to generate decorrelated signals x_{D}(b, t). The decorrelated signals x_{D}(b, t) (and the pre-processed transport audio signals x(b, n) 403) can then be mixed using any suitable mixing procedure to generate time-frequency audio signals 407.

In some examples the following mixing procedure can be used to generate the time-frequency audio signals 407:

$$y ( b , t ) = M ( k , n ) x ( b , n ) + {M}_{r} ( k , n ) {x}_{D} ( b , n )$$

where the band k is the band in which bin b resides.

As mentioned previously the notation that has been used here implies that the temporal resolution of processing matrices M(k, n) and Mᵣ(k, n) 417 and pre-processed transport audio signals x(b, n) 403 are the same. In other examples they could have different temporal resolutions. For example, the temporal resolution of the processing matrices 417 could be sparser than the temporal resolution of the pre-processed transport audio signals 403. In such examples an interpolation process, such as linear interpolation, could be applied to the processing matrices 417 so as to achieve the same temporal resolution of the pre-processed transport audio signals 403. The interpolation rate can be dependent on any suitable factor. For example, the interpolation rate can be dependent on whether or not an onset has been detected. Fast interpolation can be used if an onset has been detected and normal interpolation can be used if an onset has not been detected.

The decorrelate and mix block 405 provides the time-frequency spatial audio signals 407 as an output.

The time-frequency spatial audio signals 407 are provided as an input to an inverse filter bank 409. The inverse filter bank 409 is configured to apply an inverse transform to the time-frequency spatial audio signals 407. The inverse transform that is applied to the time-frequency spatial audio signals 407 can be a corresponding transform to the one that is used to convert the decoded transport audio signals 323 to time-frequency transport audio signals 327 in FIG. 3.

The inverse filter bank 409 is configured to provide spatial audio output 111 as an output. The spatial audio output 111 is provided in any suitable audio format.

Different examples could use different methods instead of the covariance matrix based rendering other than the example used in FIG. 4. For instance, in other examples the audio signals could be divided into directional and non-directional parts. A ratio parameter from the spatial metadata could be used to divide the signals into directional and non-directional parts. The directional part could then be positioned to virtual loudspeakers using amplitude panning or any other suitable means. The non-directional part could be distributed to all loudspeakers and decorrelated. The processed directional and non-directional parts could then be added together. Each of the virtual loudspeakers can then be processed with HRTFs to obtain the binaural output.

Systems that implement examples of the disclosure can therefore provide a distribution of indirect audio to virtual loudspeakers in which the indirect audio is not evenly distributed but instead is based on the indirect audio ratios r_{x,diff}(k, n), r_{y,diff}(k, n), and r_{z,diff}(k, n) and the directions of the virtual loudspeakers.

As an example, the non-directional sound gain for a virtual loudspeaker could be obtained by multiplying the squared x-coordinate of the virtual loudspeaker by the diffuse sound ratio r_{x,diff}(k, n), multiplying the squared y-coordinate of the virtual loudspeaker by the diffuse sound ratio r_{y,diff}(k, n), multiplying the squared z-coordinate of the virtual loudspeaker by the diffuse sound ratio r_{z,diff}(k, n), and summing the results. Then, the non-directional sound gains of all the virtual loudspeakers could be normalized so that the squared sum of them equals to one.

A similar approach could also be used for multichannel loudspeaker output, in which case the virtual loudspeakers would be replaced by actual loudspeakers.

In the examples described above the bitstream 107 only comprises a single encoded transport audio signal 319 and mixing is performed using the single transport audio signal and decorrelated versions of it. As a result, each input signal to the mixing had the same energy, and the diffuse sound ratios r_{x,diff}(k, n), r_{y,diff}(k, n), and r_{z,diff}(k, n) could be computed without taking the energy into account. It is not necessary to compute the energy for the decorrelated channels because this should correspond to the energy of the transport audio signals from which they were created (that, is the first, omnidirectional, transport audio signal). The energy values for the transport audio signals can be used, instead.

In some examples, the bitstream 107 could comprise a plurality of transport audio signals. In such examples the energy needs to be taken into account when the diffuse sound ratios r_{x,diff}(k, n), r_{y,diff}(k, n), and r_{z,diff}(k, n) are being computed. In such examples, the energies E(k, n, j) of the transport audio signals are computed in frequency bands.

$$E ( k , n , j ) = {\sum }_{b = {b}_{low} ( k )}^{{b}_{high} ( k )} {\vert {s}^{′} ( b , n , j ) \vert}^{2}$$

where s′(b, n, j) is the j:th channel signal of s′(b, n).

The diffuse sound gains can then be computed using the energies E(k, n, j) and the mixing matrix A(i, j, k, n)

$${g}_{x , diff} ( k , n ) = {\sum }_{j = 2}^{4} \vert A ( 2 , j , k , n ) E ( k , n , j ) \vert$$

$${g}_{y , diff} ( k , n ) = {\sum }_{j = 2}^{4} \vert A ( 3 , j , k , n ) E ( k , n , j ) \vert$$

$${g}_{z , diff} ( k , n ) = {\sum }_{j = 2}^{4} \vert A ( 4 , j , k , n ) E ( k , n , j ) \vert$$

It should be noted that these equations could be used for scenarios that use with a single transport audio signal, as well even though they are computationally more complex.

The rest of the processing can be performed as was presented above. That is, the diffuse sound ratios can be computed using these diffuse sound gains.

Examples of the disclosure can be implemented in systems that allow for head tracking of the listeners head orientation. In such examples the matrix A(i, j, k, n) can be rotated using a rotation matrix according to the listener head orientation prior before the diffuse sound gains g_{x,diff}(k, n), g_{y,diff}(k, n), and g_{z,diff}(k, n) are estimated. For example, when an FOA signal is generated from the transport audio signals by y(b, n)=A(k, n)s′(b, n), then a rotated FOA signal could be generated by

$${y}_{R} ( b , n ) = {\underbrace{R ( n ) A ( k , n )}}_{= \hat{A} ( k , n )} {s}^{′} ( b , n )$$

Where R(n) is an FOA rotation matrix according to the listener head orientation. The rotation matrix can mix the X, Y, Z channels to new X, Y, Z channels so that they are aligned according to the current listener head position). Therefore, using a rotated mixing matrix Â(k, n) in place of A(k, n) in the equations enables the head orientation to be taken into account.

In the above example the spatial metadata in the spatial audio signal was provided in an FOA format. Other formats could be used for the spatial metadata in other examples. In such example, the diffuse sound ratios r_{x,diff}(k, n), r_{y,diff}(k, n), and r_{z,diff}(k, n) can be estimated in a different way. For instance, in some examples the spatial metadata can comprise direction (azimuth, elevation) θ(k, n), ϕ(k, n) and direct-to-total energy ratio r(k, n) parameters. This kind of spatial metadata can be obtained from mobile devices having a microphone array attached to them or from any other suitable type of device or by using any suitable processes.

In such examples, the diffuse sound ratios can be estimated based on an average direction. This can be implemented as follows. The directions are converted to Cartesian coordinates

$${d}_{x} ( k , n ) = cos θ ( k , n ) cos ϕ ( k , n )$$

$${d}_{y} ( k , n ) = sin θ ( k , n ) cos ϕ ( k , n )$$

$${d}_{z} ( k , n ) = sin ϕ ( k , n )$$

The diffuse sound gains can be determined by averaging the absolute values of them over time, weighted by how “diffuse” the sound is estimated to be (e.g., 1−r(k, n))

$${g}_{x , diff} ( k , n ) = {\sum }_{{n}^{′} = n - N}^{n} \vert {d}_{x} ( k , {n}^{′} ) ( 1 - r ( k , {n}^{′} ) ) \vert$$

$${g}_{y , diff} ( k , n ) = {\sum }_{n ′ = n - N}^{n} \vert {d}_{y} ( k , {n}^{′} ) ( 1 - r ( k , {n}^{′} ) ) \vert$$

$${g}_{z , diff} ( k , n ) = {\sum }_{{n}^{′} = n - N}^{n} \vert {d}_{z} ( k , {n}^{′} ) ( 1 - r ( k , {n}^{′} ) ) \vert$$

where N denotes the time interval over which the averaging is performed. The averaging can also be performed using IIR (infinite impulse response) smoothing or any other suitable process. The rest of the processing can be performed as described above. For example, the diffuse sound ratios can be computed using these diffuse sound gains. These formulas for the diffuse sound gains can also be energy-weighted so that time indices n′ with a higher energy have a greater affect on the average result than time indices n′ with a lower energy.

In some examples the spatial metadata could a plurality of different types of parameters or different types of parameters could be obtained from the spatial metadata. For example, the spatial metadata could comprise both SPAR (Spatial Audio Rendering) and DirAC (Directional Audio Coding) parameters or any other suitable type of parameters. In such cases a first type of parameters could be used to compute the diffuse sound ratios and a second type of parameters could be used for the rendering. For example, the diffuse sound ratios could be computed using the SPAR parameters and the DirAC parameters could be used for the rendering.

In some examples the spatial metadata might be available in a first format for a first set of frequencies and the spatial metadata might be available in a second format for a second set of frequencies. For instance, the spatial metadata could comprise SPAR parameters for a first set of frequencies and DirAC parameters for a second set of frequencies. In these cases, different processes could be used for estimating the diffuse sound ratios for the different frequencies. In some cases, different processes can also be used for determining the rendering metadata 315 at different frequencies.

In the examples shown in FIGS. 3 and 4 the directional distribution information such as the diffuse sound ratios r_{x,diff}(k, n), r_{y,diff}(k, n), and r_{z,diff}(k, n) are estimated within the decoder 109. In some examples the directional distribution information such as the diffuse sound ratios r_{x,diff}(k, n), r_{y,diff}(k, n), and r_{z,diff}(k, n) can be estimated within the encoder 105 and then transmitted to the decoder 109. The directional distribution information can be transmitted with the spatial metadata and any other suitable parameters.

In the above examples the directional distribution information was obtained for X, Y and Z axes separately. On other examples the directional distribution information can be obtained for other coordinate systems. For instance, the diffuse component could be determined in a rotated coordinate system such that the rotation adaptively maximizes, or substantially maximizes, the energy of the first-axis diffuse component. As an example, there could be one source at 45 degrees azimuth and 45 degrees elevation, and another at −135 degrees azimuth and −45 degrees elevation (that is, at the opposite direction). In this case, an embodiment would measure and reproduce the diffuse component predominantly on that axis, instead of focusing on fixed X, Y and Z coordinates.

In some examples, the organization of the diffuse component does not need to follow any rotated or unrotated set of axes. For example, when a FOA covariance matrix is determined, based on measuring the covariance matrix of signal y(b, n)=A(k, n)s′(b, n), it is possible to use a minimum-variance distortionless response (MVDR) beamforming method to determine the spatial energy spectrum at a surrounding spatial distribution of directions. To do this the energy from d:th direction (that is corresponding to sound arriving from Direction of Arrival d (DOA_{d}) can be denoted E′(d, k, n). These energy values can be utilized to spatially weight the diffuse binaural covariance matrix

$${C}_{d} ( k , n ) = \frac{{\sum }_{d = 1}^{D} h ( {DOA}_{d} , k ) {h}^{H} ( {DOA}_{d} , k ) {E}^{′} ( d , k , n )}{{\sum }_{d = 1}^{D} {E}^{′} ( d , k , n )}$$

where h(DOA_{d}, k) is the HRTF vector for DOA_{d} and band k. In the above formula, it is possible also to use temporal averaging to prior temporal indices and apply (1−r(k, n)) weighting to the emphasize the more diffuse temporal steps at the estimate.

The above formula to determine C_{d}(k, n) can also be used when the method of determining the diffuse sound distribution follows a coordinate system such as X, Y, Z or a rotated one, by first mapping the ratio values g_{(x,y,z),diff}(k, n) (or rotated similar values) to the spatial energy distribution values E′(d, k, n), and then applying the above formula.

In the above described examples, the decorrelated sound was generated based on decorrelating the left and right pre-processed transport audio signals 403 and mixing them to obtain a residual component. In mono cases where there is a single transport audio signal this means that the mono sound is decorrelated to left and right decorrelated sounds. The left and right decorrelated sounds are mixed using a covariance-matrix based rendering scheme. This can assume an input covariance matrix (of the decorrelated part) to be a diagonal matrix.

In some examples, the mono transport audio signal can be decorrelated just once and a two-channel signal can be generated by providing to the first channel the decorrelated signal, and an inverted (multiplied by −1) decorrelated signal to the second channel. In such cases, the input covariance matrix of the decorrelated part is not diagonal, but the cross-term of the covariance matrix is the same as the diagonal value, but with a negative sign. This procedure can be used for the situations where the decorrelators themselves fall short in generating signals that can be assumed to be fully incoherent.

In some examples, the diffuse binaural covariance matrix can be generated based on the estimated FOA covariance matrix. In such examples, the transport signals covariance matrix can be determined by

$${C}_{s} ( k , n ) = {\sum }_{b = {b}_{low} ( k )}^{{b}_{high} ( k )} s ( b , n ) {s}^{H} ( b , n )$$

Then, Cₛ(k, n) is zero-padded to size 4×4, and the values of the first diagonal value are placed on the zero-padded diagonal values, to obtain a padded matrix C_{s′}(k, n). The FOA covariance matrix then is

$${C}_{FOA} ( k , n ) = A ( k , n ) {C}_{s ′} ( k , n ) {A}^{H} ( k , n )$$

The FOA matrix can be rotated according to the head-orientation by

$${C}_{FOA , R} ( k , n ) = R ( n ) {C}_{FOA} ( k , n ) {R}^{H} ( n )$$

Then, the diffuse binaural covariance matrix can be determined as

$${C}_{d} ( k , n ) = {H}_{FOA} ( k ) {C}_{FOA , R} ( k , n ) {H}_{FOA}^{H} ( k )$$

where H_{FOA}(k) is a FOA-to-binaural processing matrix. In this method, if the spatial metadata denotes that audio is indirect audio then the target covariance matrix is predominantly based on the FOA-to-binaural rendering scheme. However, if the spatial metadata denotes the sound to be direct audio then the target covariance matrix is predominantly based on the rendering metadata consisting of the direction parameters. This covariance matrix C_{d}(k, n) can also be estimated by first generating a signal

$${y}_{d} ( b , n ) = {H}_{FOA} ( k ) R ( n ) A ( k , n ) {s}^{′} ( b , n )$$

and then measuring the covariance matrix of signal y_{d}(b, n).

FIG. 5 schematically shows an example apparatus 501 that could be used in some examples of the disclosure. The apparatus 501 could comprise a controller apparatus and could be provided within an electronic device such as a telephone, a camera, a computing device, a teleconferencing apparatus or any other suitable type of device.

In the example of FIG. 5 the apparatus 501 comprises at least one processor 503 and at least one memory 505. It is to be appreciated that the apparatus 501 could comprise additional components that are not shown in FIG. 5.

In the example of FIG. 5 the implementation of the apparatus 501 can be implemented as processing circuitry. In some examples the apparatus 501 can be implemented in hardware alone, have certain aspects in software including firmware alone or can be a combination of hardware and software (including firmware).

As illustrated in FIG. 5 the apparatus 501 can be implemented using instructions that enable hardware functionality, for example, by using executable instructions of a computer program 507 in a general-purpose or special-purpose processor 503 that can be stored on a computer readable storage medium (disk, memory etc.) to be executed by such a processor 503.

The processor 503 is configured to read from and write to the memory 505. The processor 503 can also comprise an output interface via which data and/or commands are output by the processor 503 and an input interface via which data and/or commands are input to the processor 503.

The memory 505 is configured to store a computer program 507 comprising computer program instructions (computer program code 509) that controls the operation of the apparatus 501 when loaded into the processor 503. The computer program instructions, of the computer program 507, provide the logic and routines that enables the apparatus 501 to perform the methods illustrated in FIGS. 2 to 4. The processor 503 by reading the memory 505 is able to load and execute the computer program 507.

The apparatus 501 therefore comprises: at least one processor 503; and at least one memory 505 including computer program code 509, the at least one memory 505 and the computer program code 509 configured to, with the at least one processor 503, cause the apparatus 501 at least to perform:
obtaining a spatial audio signal comprising one or more audio signals and associated spatial metadata wherein the associated spatial metadata is configured to enable rendering of spatial audio from the one or more audio signals and wherein the spatial audio comprises direct audio and indirect audio;
using, at least the associated spatial metadata to determine directional distribution information for the indirect audio;
determining rendering information corresponding to the determined directional distribution information; and
enabling rendering of the spatial audio using the determined rendering information, the one or more audio signals and the associated spatial metadata.

As illustrated in FIG. 5 the computer program 507 can arrive at the apparatus 501 via any suitable delivery mechanism 511. The delivery mechanism 511 can be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 507. The delivery mechanism can be a signal configured to reliably transfer the computer program 507. The apparatus 501 can propagate or transmit the computer program 507 as a computer data signal. In some examples the computer program 507 can be transmitted to the apparatus 501 using a wireless protocol such as Bluetooth, Bluetooth Low Energy, Bluetooth Smart, 6LoWPan (IPᵥ6 over low power personal area networks) ZigBee, ANT+, near field communication (NFC), Radio frequency identification, wireless local area network (wireless LAN) or any other suitable protocol.

The computer program 507 comprises computer program instructions for causing an apparatus 501 to perform at least the following:
obtaining a spatial audio signal comprising one or more audio signals and associated spatial metadata wherein the associated spatial metadata is configured to enable rendering of spatial audio from the one or more audio signals and wherein the spatial audio comprises direct audio and indirect audio;
using, at least the associated spatial metadata to determine directional distribution information for the indirect audio;
determining rendering information corresponding to the determined directional distribution information; and
enabling rendering of the spatial audio using the determined rendering information, the one or more audio signals and the associated spatial metadata.

The computer program instructions can be comprised in a computer program 507, a non-transitory computer readable medium, a computer program product, a machine readable medium. In some but not necessarily all examples, the computer program instructions can be distributed over more than one computer program 507.

Although the memory 505 is illustrated as a single component/circuitry it can be implemented as one or more separate components/circuitry some or all of which can be integrated/removable and/or can provide permanent/semi-permanent/dynamic/cached storage.

Although the processor 503 is illustrated as a single component/circuitry it can be implemented as one or more separate components/circuitry some or all of which can be integrated/removable. The processor 503 can be a single core or multi-core processor.

References to “computer-readable storage medium”, “computer program product”, “tangibly embodied computer program” etc. or a “controller”, “computer”, “processor” etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term “circuitry” can refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software might not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the FIGS. 2 to 4 can represent steps in a method and/or sections of code in the computer program 507. The illustration of a particular order to the blocks does not necessarily imply that there is a required or preferred order for the blocks and the order and arrangement of the block can be varied. Furthermore, it can be possible for some blocks to be omitted.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. An apparatus, comprising:
at least one processor; and
at least one memory storing instructions that, when executed with the at least one processor, cause the apparatus at least to:
obtain a spatial audio signal comprising one or more audio signals and associated spatial metadata wherein the associated spatial metadata is configured to enable rendering of spatial audio from the one or more audio signals and wherein the spatial audio comprises direct audio and indirect audio;
determine directional distribution information for the indirect audio using at least the associated spatial metadata;
determine rendering information corresponding to the determined directional distribution information; and
enable rendering of the spatial audio using the determined rendering information, the one or more audio signals, and the associated spatial metadata.

2. An apparatus as claimed in claim 1, wherein the indirect audio comprises non-directional audio.

3. An apparatus as claimed in claim 1, wherein the indirect audio comprises diffuse audio.

4. An apparatus as claimed in claim 1, wherein the determined directional distribution information indicates one or more directions associated with the indirect audio.

5. An apparatus as claimed in claim 1, wherein the rendering information comprises a target covariance matrix of the audio signals.

6. An apparatus as claimed in claim 1, wherein the rendering information comprises diffuse sound gains for channels of a multichannel loudspeaker arrangement.

7. An apparatus as claimed in claim 1, wherein the instructions, when executed with the at least one processor, cause the apparatus to use, at least the associated spatial metadata, to determine direction information for the direct audio.

8. An apparatus as claimed in claim 1, wherein the associated spatial metadata comprises information that enables mixing of audio signals so as to enable rendering of the spatial audio in a selected audio format.

9. An apparatus as claimed in claim 1, wherein the associated spatial metadata comprises, for one or more frequency sub-bands, information indicative of at least one of:
a sound direction; or
sound directionality.

10. An apparatus as claimed in claim 1, wherein the associated spatial metadata comprises at least one of:
one or more prediction coefficients for one or more frequency sub-bands; or
one or more coherence parameters.

11-12. (canceled)

13. A method, comprising:
obtaining a spatial audio signal comprising one or more audio signals and associated spatial metadata wherein the associated spatial metadata is configured to enable rendering of spatial audio from the one or more audio signals and wherein the spatial audio comprises direct audio and indirect audio;
using, at least the associated spatial metadata to determine directional distribution information for the indirect audio;
determining rendering information corresponding to the determined directional distribution information; and
enabling rendering of the spatial audio using the estimated target spatial features, the one or more audio signals, and the associated spatial metadata.

14. A method as claimed in claim 13, wherein the indirect audio comprises at least one of:
non-directional audio; or
diffuse audio.

15. (canceled)

16. A method as claimed in claim 13, wherein the determined directional distribution information indicates one or more directions associated with the indirect audio.

17. A method as claimed in claim 13, wherein the rendering information comprises a target covariance matrix of the audio signals.

18. A method as claimed in claim 13, wherein the rendering information comprises diffuse sound gains for channels of a multichannel loudspeaker arrangement.

19. A method as claimed in claim 13, wherein using at least the associated spatial metadata comprises determining direction information for the direct audio.

20. A method as claimed in claim 13, wherein the associated spatial metadata comprises information that enables mixing of audio signals so as to enable rendering of the spatial audio in a selected audio format.

21. A method as claimed in claim 13, wherein the associated spatial metadata comprises at least one of:
for one or more frequency sub-bands, information indicative of at least one of:
a sound direction; or
sound directionality; or
for one or more frequency sub-bands, one or more prediction coefficients.

22. A method as claimed in claim 13, wherein the associated spatial metadata comprises at least one of:
one or more prediction coefficients for one or more frequency sub-bands; or
one or more coherence parameters.

23. A non-transitory program storage device readable with an apparatus, tangibly embodying a program of instructions executable with the apparatus for performing operations comprising:
obtaining a spatial audio signal comprising one or more audio signals and associated spatial metadata wherein the associated spatial metadata is configured to enable rendering of spatial audio from the one or more audio signals and wherein the spatial audio comprises direct audio and indirect audio;
using, at least the associated spatial metadata to determine directional distribution information for the indirect audio;
determining rendering information corresponding to the determined directional distribution information; and
enabling rendering of the spatial audio using the estimated target spatial features, the one or more audio signals, and the associated spatial metadata.

24. (canceled)
